(19) United States
(12) Patent Application Publication
(10) Pub. No.: US 2022/0315458 A1
(43) Pub. Date: Oct. 6, 2022

(54) WATER TREATMENT

(71) Applicant: Control Chemicals (Pty) Ltd., Johannesburg (ZA)

(72) Inventor: Peter James BUCHAN, Johannesburg (ZA)

(73) Assignee: Control Chemicals (Pty) Ltd., Johannesburg (ZA)

(21) Appl. No.: 17/709,918

(22) Filed: Mar. 31, 2022

(30) Foreign Application Priority Data
Mar. 31, 2021 (ZA) 2021/02172

(51) Int. Cl. C02F 1/50; C02F 1/68

(52) U.S. Cl. CPC C02F 1/50; C02F 1/687; C02F 2103/42

(57) ABSTRACT

A base member for a water treatment chemical dispensing container comprises a centrally located raised portion having a top and sides that depend from the top. It further comprises a base portion surrounding the raised portion and relative to which the raised portion is raised such that the sides of the raised portion extend at least between the base portion and the top of the raised portion. A peripheral wall bordering and thus extending around the base portion, with a channel thus being defined around the raised portion between sides of the raised portion and the peripheral wall, is also provided. The top of the raised portion comprises a hollow, operatively upwardly open receptacle. Furthermore, one or more apertures are provided in the sides of the raised portion, adjacent to the top.

The present application claims the priority benefit of South African Provisional Application No. 2021/02172, filed Mar. 31, 2021, the entire contents of which are hereby incorporated by reference.

### FIELD OF THE INVENTION

THIS INVENTION relates to water treatment, e.g. treatment of bodies of water contained in swimming pools. The invention provides a base member for a water treatment chemical dispensing container. The invention also provides a water treatment chemical dispensing container. The invention further provides a water treatment chemical dispensing container assembly. The invention extends to a method of treating water using the assembly.

### BACKGROUND TO THE INVENTION

WATER-SOLUBLE, CHLORINE-BASED WATER TREATMENT CHEMICALS, such as calcium hypochlorite, are well-known for use in the treatment of water. Such chemicals are commonly used to disinfect drinking water and to sanitize swimming pool water, through dissolution thereof in the water.

In treating a body of swimming pool water with calcium hypochlorite, for example, the calcium hypochlorite is usually provided in solid form, e.g. as a tablet, inside a water treatment chemical dispensing container that is located in the body of water. Usually, such a container, whether for the dispensing of calcium hypochlorite or another water-soluble water treatment chemical, would be configured to float in the body of water, such that a portion of the container containing the calcium hypochlorite is submerged beneath a surface of the body of water.

The container would typically have one or more apertures which allow water to access and contact solid calcium hypochlorite inside the container, and thereby dissolve solid calcium hypochlorite inside the container. Thus, a calcium hypochlorite solution is formed inside the container.

The calcium hypochlorite solution then seeps into the body of water through the same apertures through which water originally entered the container, thus treating the body of water with calcium hypochlorite.

There are, however, challenges in using this approach to treat water effectively, specifically with calcium hypochlorite. These include that calcium hypochlorite dissolves comparatively rapidly and unevenly and contains both insoluble and/or inert material in its chemical structure. These inert materials crystallize easily as tablets dissolve, thereby blocking the dispensing apertures of a dispensing container.

Rapid dissolution of calcium hypochlorite from tablets thereof also often result in such tablets losing their structural integrity and breaking up, causing chunks or granules thereof to clog dispensing apertures.

Further, in swimming pools, the dissolution rate of calcium hypochlorite tends to vary widely. In busy, warm pools, calcium hypochlorite dissolves even more rapidly. If one tries to address this by designing a dispensing container that slows dispensing of calcium hypochlorite solution down too much, then in quiet times such dispensing containers tend to release too little calcium hypochlorite, which not only impairs disinfection but also increases the risk of apertures clogging up, as well as the cost of treatment. When the water being treated is cold, or pool water calm or stagnant for extended periods of time e.g. in winter times, the dispensing apertures may fully seal up at some point.

The inventor has recognized the abovementioned challenges, which the present invention seeks to address.

### SUMMARY OF THE INVENTION

ACCORDING TO ONE ASPECT OF THE INVENTION IS PROVIDED a base member for a water treatment chemical dispensing container, the base member comprising

a centrally located raised portion having a top and sides that depend from the top;

a base portion surrounding the raised portion and relative to which the raised portion is raised such that the sides of the raised portion extend at least between the base portion and the top of the raised portion; and

a peripheral wall bordering and thus extending around the base portion, with a channel thus being defined around the raised portion between sides of the raised portion and the peripheral wall.

The top of the raised portion may comprise a hollow, operatively upwardly open receptacle.

The term “operatively upwardly” should be interpreted with reference to an upright orientation of a dispensing body of a water treatment chemical dispensing container, as hereinafter described.

Preferably, one or more apertures are provided in the sides of the raised portion, adjacent to the top.

The sides of the raised portion may provide a shoulder ahead of the top.

The sides of the raised portion may taper toward the top, and thus the raised portion may be generally frustoconical.

When the sides of the raised portion provide a shoulder, the aperture/s in the sides of the raised portion may be provided between the shoulder and the top.

The apertures may be laterally open apertures, i.e. accessible through the sides of the raised portion.

The receptacle may be generally concave, e.g. cup-shaped.

The base member may be adapted to be a removable part of a water treatment chemical dispensing container in use. More specifically, the peripheral wall of the base member may comprise mounting formations engageable with complementary mounting formations of such a dispensing container.

For example, the mounting formations may comprise screw thread for screwing engagement with complementary screw thread of such a dispensing container, or continuous or interrupted ridges for engagement with corresponding ridges of such a dispensing container, to provide an interference or snap fit between the respective ridges.

Alternatively, the base member may form an integral part of such a dispensing container.

The dispensing container may comprise an elongate hollow water treatment chemical dispensing body configured to contain, in use, a stacked arrangement of water treatment chemical tablets comprising water treatment chemical in solid form and to be submerged, in use, beneath a surface of a body of water.

The dispensing body may terminate at respective opposite open ends thereof

The dispensing body may provide mounting formations for mounting of the base member thereto, more specifically for mounting of the base member at one end thereof, to close and thus provide a base to the dispensing body when the dispensing body is in an upright orientation.

When the base member is integrally formed with the dispensing body, it may be located at the same location as described above when the base member is removably mounted to the dispensing body.

The dispensing body may be cylindrical.

The dispensing body may have a circular cross section.

Apertures may be defined in the dispensing body, for water to enter the dispensing body in use and thus access and dissolve water treatment chemical from water treatment chemical tablets that are in use contained in the dispensing body.

The apertures in the dispensing body may include apertures that extend along a length of the dispensing body.

The apertures that extend along the length of the dispensing body may be relatively short or may be elongate.

In one embodiment of the invention, the dispensing body may define a number, e.g. two, sets of circumferentially spaced elongate dispensing apertures that extend along the length of the dispensing body, the sets being spaced from each other along the length of the dispensing body (i.e. may be longitudinally spaced from each other).

The dispensing body or the base member may include a tablet support for supporting tablets comprising water treatment chemical inside the dispensing body, in use, at least when the body is in an upright configuration.

In one embodiment of the invention, the tablet support may be provided by one or more tablet support ridges that extend circumferentially, in a continuous or interrupted manner, along an interior sidewall of the dispensing body or along the peripheral wall of the base member.

One such ridge may be located adjacent to, but spaced from, a top of the base member, such that tablets comprising water treatment chemical in use are located slightly above the top of the raised portion of the base member when the dispensing body is in an upright configuration.

Another such ridge may be located further along the dispensing body, typically around half-way between the base member and a top, or head, of the dispensing body. Thus, tablets inside the dispensing body may be grouped into two groups—one, operatively lower, group being located immediately above the base member, supported by the one ridge, and another group being located above the lower group, supported by the other ridge.

The other ridge described above, located around half-way along the length of the dispensing body, may be replaced with a spacer between two groups of tablets that are located inside the dispensing body in use.

The dispensing container may further comprise a buoyant body, either being integrally formed with or a removable part of the dispensing container.

The buoyant body may be configured to render the dispensing container, when filled with water treatment chemical tablets, buoyant in water, such that the dispensing container can, in use, float in a body of water with the dispensing body submerged below a surface of the body of water in an upright orientation.

The buoyant body may typically be a hollow, closed body, filled with air.

When the buoyant body is a removable part of the dispensing container, the buoyant body may be adapted for such removable mounting. More specifically, buoyant body may comprise mounting formations engageable with complementary mounting formations of the dispensing container.

For example, the mounting formations may comprise screw thread for screwing engagement with complementary screw thread of such a dispensing container, or continuous or interrupted ridges for engagement with corresponding ridges on such a dispensing container, to provide an interference or snap fit between the respective ridges.

The dispensing body may provide mounting formations for mounting of the buoyant body thereto, more specifically for mounting of the buoyant body at an end thereof that is opposite to the end at which the base member is located, to close and thus provide a head to the dispensing body when the dispensing body is in an upright orientation.

ACCORDING TO ANOTHER ASPECT OF THE INVENTION IS PROVIDED a water treatment chemical dispensing container for dispensing a water-soluble water treatment chemical into a body of water to be treated with the water-soluble water treatment chemical, wherein the dispensing container comprises

an elongate, hollow water treatment chemical dispensing body configured to contain, in use, a stacked arrangement of water treatment chemical tablets comprising water treatment chemical in solid form and to be submerged, in use, beneath a surface of the body of water;

optionally, apertures defined in the dispensing body, for water to enter the dispensing body in use and thus access and dissolve water treatment chemical from the water treatment chemical tablets; a base member in accordance with the invention, removably mounted to or integral with the dispensing body, that provides a base of the dispensing body at one end thereof, with reference to the dispensing body in an upright configuration; and

a buoyant body, removably mounted to or integral with the dispensing body, that provides a head of the dispensing body at another end thereof, the buoyant body being configured to render the dispensing container buoyant in water when filled with water treatment chemical tablets, in use, such that the dispensing container can, in use, float in a body of water with the dispensing body submerged below a surface of the body of water in an upright orientation.

The dispensing body may be as described in accordance with the base member of the invention.

The optional apertures in the dispensing body are preferably provided.

The buoyant body may also be as described in accordance with the base member of the invention.

ACCORDING TO ANOTHER ASPECT OF THE INVENTION THERE IS PROVIDED a water treatment chemical dispensing assembly comprising
a water treatment chemical dispensing container as hereinbefore described; and
a stack of tablets comprising water treatment chemical, located inside the dispensing body of the dispensing container.

The stack of tablets may, more specifically, be located inside the dispensing body of the dispensing container such that a lowermost tablet of the stack of tablets is supported on the tablet support at least when the dispensing body is in an upright configuration.

The stack of tablets may comprise a plurality, i.e. two or more, tablets, located contiguously with each other.

The stack of tablets may be a partially wrapped stack of tablets. More specifically, the stack of tablets may be circumferentially wrapped, such that only axial end surfaces of outermost tablets of the stack are exposed.

In one embodiment of the invention, two or more stacks of tablets, in a stacked configuration with each other, may be provided. It will be understood that such respective stacks of tablets may then be individually wrapped.

In such an embodiment, the assembly may include a removable spacing member located between respective stacks of tablets. The spacing member may have a bow-tie shaped cross section.

Alternatively, the spacing member may be omitted, if the dispensing body comprises two tablet support ridges as described above.

The water treatment chemical comprised by the water treatment chemical tablets, may be calcium hypochlorite.

ACCORDING TO A FURTHER ASPECT OF THE INVENTION THERE IS PROVIDED a method of treating water, the method including submerging a dispensing body of a water treatment chemical dispensing assembly as hereinbefore described beneath the surface of a body of water to be treated.

### DETAILED DESCRIPTION OF AN ILLUSTRATIVE EMBODIMENT

THE INVENTION will now be described in more detail with reference to an illustrative embodiment thereof, as diagrammatically shown in the accompanying drawings.

In the drawings,

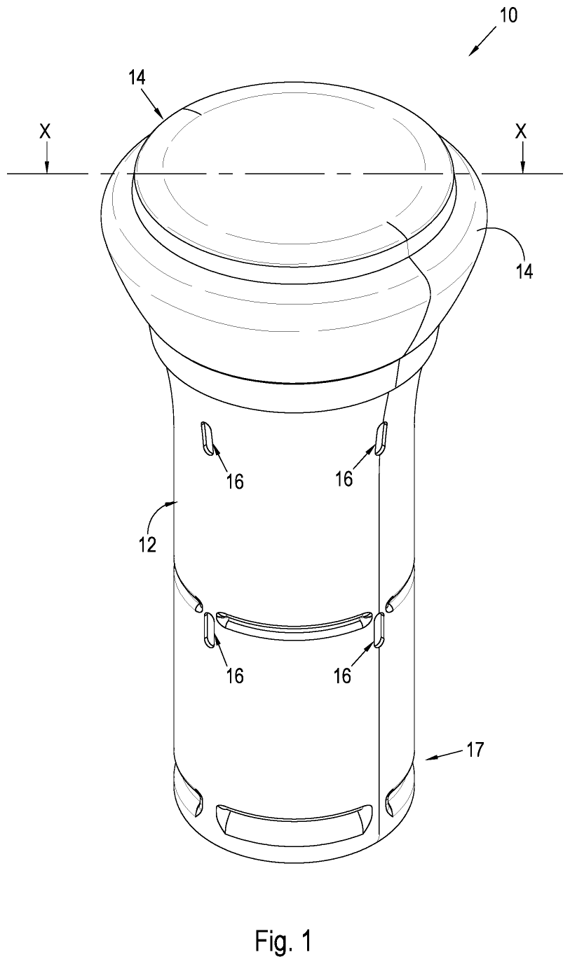

FIG. 1 shows, in one three-dimensional view, a water treatment chemical dispensing container according to the invention;

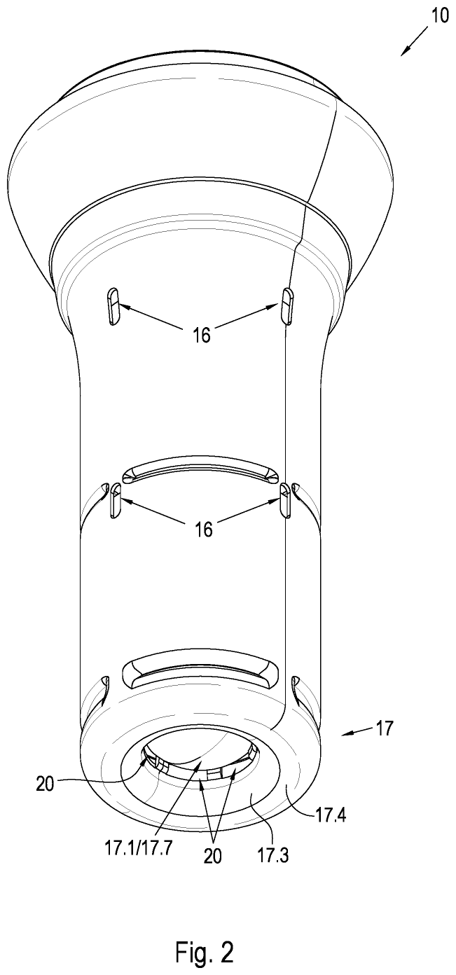

FIG. 2 shows, in another three-dimensional view, the water treatment chemical dispensing container of FIG. 1;

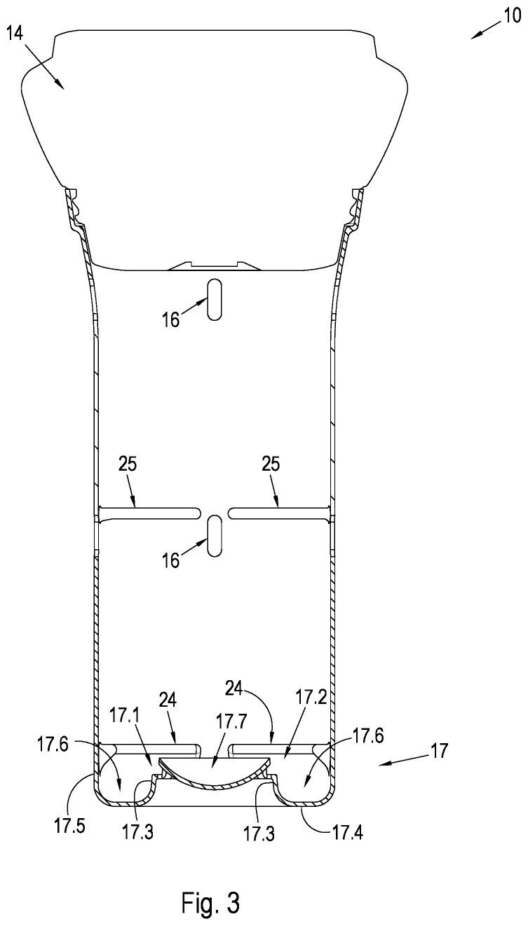

FIG. 3 shows, in longitudinal section, the water treatment chemical dispensing container of FIG. 1, along X-X; and

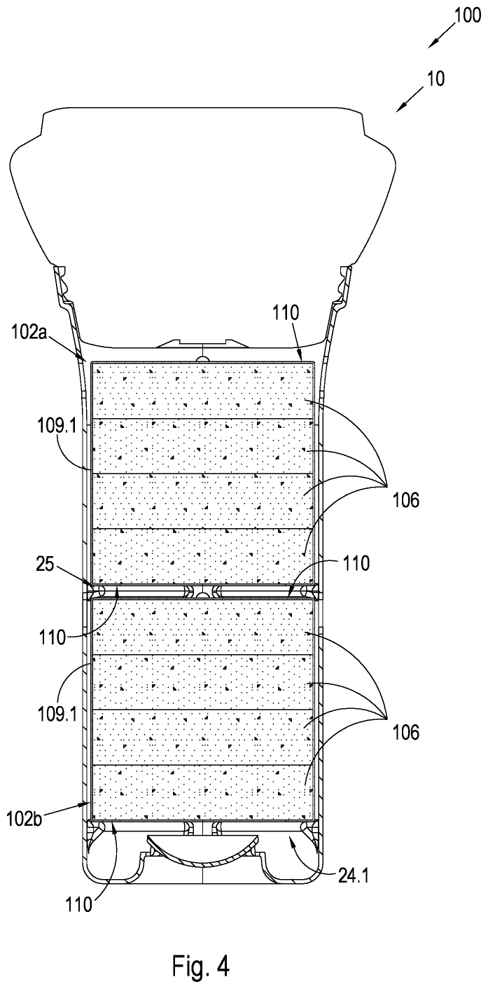

FIG. 4 shows, in longitudinal section, the water treatment chemical dispensing container of FIG. 1 as a water treatment chemical dispensing assembly.

Referring to the drawings, and particularly FIGS. 1 to 3, reference numeral 10 generally indicates a water treatment chemical dispensing container according to the invention.

The dispensing container 10 comprises an elongate hollow water treatment chemical dispensing body 12.

The dispensing body 12 is circular cylindrical, thus being configured to contain, in use, one or more stacked arrangements of circular cylindrical water treatment chemical tablets comprising water treatment chemical, such as calcium hypochlorite, in solid form (see e.g. FIG. 4).

The dispensing container 10 also includes a buoyant body 14, to render the dispensing container 10 buoyant in water so that it may, in use, with water treatment chemical tablets contained in the dispensing body 12, float in a body of water to be treated, with the dispensing body 12 oriented upright and located beneath a surface of the body of water.

The buoyant body 14 is removably mounted to the dispensing body 12 by complementary engaging screw-threads.

The dispensing body 12 has two longitudinally spaced sets of circumferentially spaced apertures 16.

In use, water may enter the dispensing body 12 through the apertures 16 and thus access and dissolve water treatment chemical from water treatment chemical tablets contained in the dispensing body 12 in use.

Water in which water treatment chemical has dissolved may also leave the dispensing body through the apertures 16, in use, thereby to treat water outside of the dispensing body with water treatment chemical.

The dispensing body 12 further has a base member 17, according to the invention. The base member 17 is illustrated as being integral with the dispensing body 12, but typically it would, in an embodiment in which the dispensing body 12 has a ridge 25 as hereinafter described, be removably mounted to the dispensing body 12 by means of complementary engaging screw threads or an interference fit, for the dispensing container 10 to be reusable.

The base member 17 comprises a centrally located raised portion 17.1 having a top 17.2 and sides 17.3 that depend from the top 17.2. The sides 17.3 taper toward the top 17.2.

The base member 17 further comprises a base portion 17.4 that surrounds the raised portion 17.1 and relative to which the raised portion 17.1 is raised, such that the sides 17.3 of the raised portion 17.1 extend between the base portion 17.4 and the top 17.2 of the raised portion 17.1.

The base member 17 also comprises a peripheral wall 17.5 which borders, and thus extends around, the base portion 17.4, with a channel 17.6 thus being defined around the raised portion 17.1 between sides 17.3 of the raised portion and the peripheral wall 17.5.

The top 17.2 of the raised portion 17.1 comprises a hollow, operatively upwardly open receptacle 17.7 that is generally concave.

A plurality of circumferentially spaced laterally open apertures 20 are provided in the sides 17.3 of the raised portion 17.1, adjacent to the top 17.2 and more specifically between the receptacle 17.7 and a shoulder provided by the sides 17.3 of the raised portion 17.1.

The dispensing body 12 also includes two tablet supports in the form of two interrupted circumferentially extending tablet support ridges 24, 25, inside the dispensing body 12, for supporting, in use, respective stacked arrangements of tablets comprising water treatment chemical, inside the dispensing body 12, when the body is in an upright configuration (see FIG. 4).

The ridge 24 may be provided as part of the base member 17, to allow for it to be removed from the dispensing body 12 and thus allow for the insertion of fresh treatment chemical tablets into the interior of the dispensing body 12, operatively below the ridge 25. In such a case, the dispensing container 10 may be reusable. Alternatively, if the dispensing container 10 is not a reusable container, then the ridge 24 may be provided as part of the dispensing body 12.

As a further alternative, the ridge 24 may be part of the dispensing body 12 but the dispensing container may still be reusable by omitting the ridge 25 and replacing it with a removable spacing element that would in use be located between respective groups of stacked tablets. Such a spacing element may, for example, have a bow-tie shaped cross section. In such a case, the head 14 of the dispensing container 10 would be removable, to allow for loading of fresh treatment chemical tablets into the interior of the dispensing body 12.

Referring now to FIG. 4, reference numeral 100 generally indicates a water treatment chemical dispensing assembly according to the invention.

The assembly 100 comprises the water treatment chemical dispensing container 10 as hereinbefore described and, inside the dispensing body 12 of the container 10, two stacked arrangements 102a, 102b of tablets 106 comprising water treatment chemical.

The stacked arrangements of tablets 102a, 102b are separated by the ridge 25.

In an upright configuration of the container 10 as illustrated, the lower of the two stacked arrangements of tablets 102b rests on the support ridge 24.

The stacks of tablets 102a, 102b are individually wrapped in respective polyvinyl chloride (PVC) sleeves 109 such that only axial end surfaces 110 of the axially outermost tablets thereof are exposed for water contact.

The applicant has found that molding the base member 17 is facilitated if the sides 17.3 of the raised portion 17.1 taper toward the top 17.2 and have a small step/shoulder along the lengths thereof, adjacent to the apertures 20 that are defined in the sides 17.3 or the raised portion 17.1. The provision of such a step could, however, result in particles coming to rest on the step/shoulder, rather than falling into the channel 17.6, and consequently could result in blockage of the apertures 20.

By providing the receptacle 17.7, the applicant has inventively provided for pieces of water treatment chemical, breaking off from tablets thereof contained inside the dispensing body in use, to be captured when water is calm, so that they can lie in the receptacle and release their chlorine. When water is agitated, these pieces will bounce out of the receptacle and, because of the angle and sharp lip of the upper edge of the receptacle, float over the edge and the shoulder, away from the apertures 20, thus landing in the channel 17.6.

Discussion

INDIVIDUAL WRAPPING of the stacked arrangements of tablets in a manner that exposes, for water contact, only the axial outer end surfaces of axially outermost tablets, results in a more even dissolution of water treatment chemical from the arrangements of tablets since the surface area from which dissolution occurs remains substantially constant as the tablets are axially eroded.

Sleeving the stacked arrangements of tablets also keeps both the stack and tablets of the stack intact and suspended in their slots, at least until a sufficient degree of dissolution of water treatment chemical has taken place for one or more of the tablets to break up.

Such a break-up releases particulate material in the form of flakes, chunks and granules, into the interior of the dispensing body, of a particle size that would normally clog up dispensing apertures conventionally located adjacent to the base member of existing water treatment chemical dispensing containers.

In the present invention, such clogging is completely avoided, through a number of novel and inventive measures.

In one respect, the raised portion of the base member with lateral apertures adjacent to its top, provides for flakes, chunks and granules released from the break-up of tablets to move past the apertures, contact the tapered slope of the sides of the raised portion, and collect down to the channel provided between the sides of the raised portion and the peripheral wall of the base member. Here, such flakes, chunks and granules can dissolve without risk of closing up the apertures.

Furthermore, location of apertures adjacent to the top of the base member also allows chlorine that dissolves from the channel, and chlorine dissolving from the tablets remaining above the base member, to be dosed into the body of water to be treated from adjacent a distal end of the dispensing container.

To the applicant's understanding, it is preferred to dose chlorine into a body of water to be treated as far as possible beneath the surface, since dissolved chlorine (HOCI) is heavier than water and since it is preferable to remove it as far from exposure to direct sunlight as possible.

In existing devices, effectively achieving this was obstructed by blockage of apertures and was also problematic since flakes, chunks and granules breaking up from the tablets, when exiting a dispensing container in solid form, would fall to the bottom of a pool, for example, and cause stains to the pool structure, which is typically of marbelite/fiberglass etc.

Only having one exit point, i.e. adjacent to the base member of existing devices, for dissolved chlorine the applicant also found problematic, since the risk of clogging is significantly increased. This present invention addresses this by providing the longitudinally spaced arrangements of circumferentially spaced apertures, which the applicant has found to allow lateral flow of water through the dispensing body.

Thus,

(i) chlorine release is always assured, clogging is prevented,

(ii) a significant percentage of total chlorine is released from the bottom, deeper in the water, with little/no risk of large particles landing on the pool-floor, and

(iii) little to no risk of large particles exiting laterally given the limited number of elongate apertures.

In these respects, at least, the inventor believes that the present invention overcomes the difficulties associated the existing devices.

1. A base member for a water treatment chemical dispensing container, the base member comprising
a centrally located raised portion having a top and sides that depend from the top;
a base portion surrounding the raised portion and relative to which the raised portion is raised such that the sides of the raised portion extend at least between the base portion and the top of the raised portion, and
a peripheral wall bordering and thus extending around the base portion, with a channel thus being defined around the raised portion between sides of the raised portion and the peripheral wall, wherein
the top of the raised portion comprises a hollow, operatively upwardly open receptacle, and one or more apertures are provided in the sides of the raised portion, adjacent to the top.

2. The base member according to claim 1, wherein the sides of the raised portion provide a shoulder ahead of the top.

3. The base member according to claim 2, wherein the aperture/s in the sides of the raised portion are provided between the shoulder and the top.

4. The base member according to claim 1, wherein the receptacle is generally concave.

5. A water treatment chemical dispensing container for dispensing a water-soluble water treatment chemical into a body of water to be treated with the water-soluble water treatment chemical, wherein the dispensing container comprises
an elongate, hollow water treatment chemical dispensing body terminating at respective opposite open ends thereof and configured to contain, in use, a stacked arrangement of water treatment chemical tablets comprising water treatment chemical in solid form and to be submerged, in use, beneath a surface of the body of water;
apertures defined in the dispensing body, for water to enter the dispensing body in use and thus access and dissolve water treatment chemical from the water treatment chemical tablets;
a base member in accordance with claim 1, removably mounted to or integral with the dispensing body, that provides a base of the dispensing body at one end thereof, with reference to the dispensing body in an upright configuration; and
a buoyant body, removably mounted to or integral with the dispensing body, that provides a head of the dispensing body at another end thereof, the buoyant body being configured to render the dispensing container buoyant in water when filled with water treatment chemical tablets, in use, such that the dispensing container can, in use, float in a body of water with the dispensing body submerged below a surface of the body of water in an upright orientation.

6. The dispensing container according to claim 5, wherein base member is removably mounted to the dispensing body and the peripheral wall of the base member comprises mounting formations that are engaged with complementary mounting formations provided by the dispensing body.

7. The dispensing container according to claim 5, wherein the buoyant body is a hollow, closed body, filled with air.

8. The dispensing container according to claim 5, wherein the buoyant body is removably mounted to the dispensing body and comprises mounting formations engageable with complementary mounting formations provided by the dispensing body.

9. A water treatment chemical dispensing assembly comprising
a water treatment chemical dispensing container according to claim 5; and
a stack of tablets comprising water treatment chemical, located inside the dispensing body of the dispensing container.

10. The dispensing assembly according to claim 9, wherein the water treatment chemical comprised by the water treatment chemical tablets is calcium hypochlorite.
